(19) United States
(12) Patent Application Publication
(10) Pub. No.: US 2009/0151500 A1
(43) Pub. Date: Jun. 18, 2009

(54) MECHANISM FOR CHANGING RACK STROKE OF STEERING SYSTEM

(75) Inventor: Kisung PARK, Hwaseong-si (KR)

Correspondence Address: MORGAN, LEWIS & BOCKIUS LLP (SF), One Market, Spear Street Tower, Suite 2800, San Francisco, CA, 94105, US

(73) Assignees: Kia Motors Corporation, Seoul (KR); Hyundai Motor Company, Seoul (KR)

(21) Appl. No.: 12/248,214

(22) Filed: Oct. 9, 2008

(30) Foreign Application Priority Data
Dec. 15, 2007 (KR) 10-2007-0131756

(51) Int. Cl. B62D 1/20

(52) U.S. Cl. 74/498

(57) ABSTRACT

A mechanism for changing a rack stroke of a steering system includes a limiter that is rotated by a motor, a stopper that limits the rack stroke by contacting the limiter, and a controller that controls the motor based on vertical motion of a wheel. The limiter includes one or more first spiral slopes. The stopper includes one or more second spiral slopes in contact with the first spiral slopes. The limiter may be ring-shaped. The first spiral slopes may be disposed along the circumference of the limiter. The limiter may further include one or more rotation stopping blocks which protrude between the spiral slopes. The stopper may include a center body that is rotatably inserted between the rotation stopping blocks, and one or more protrusions that radially protrude from the center body. The second spiral slopes may be disposed on the protrusions.

### CROSS-REFERENCE TO RELATED APPLICATIONS

The present application is based on, and claims priority from, Korean Application Serial Number 10-2007-0131756, filed on Dec. 15, 2007, the disclosure of which is hereby incorporated by reference herein in its entirety.

### FIELD OF THE INVENTION

The present invention relates to a mechanism for changing a rack stroke of a steering system to change the vehicle's turning radius.

### BACKGROUND OF THE INVENTION

Steering rack stroke restrictors are sometimes used to prevent interference of snow chains with a car body. The stroke is increased to reduce the turning radius at other times. The known system restricts the rack stroke assuming the worst conditions, i.e. the largest possible tire bounce. Most tire bounce is only around 30% of the maximum.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

A mechanism for changing a rack stroke of a steering system includes a limiter that is rotated by a motor, a stopper that limits the rack stroke by contacting the limiter, and a controller that controls the motor based on vertical motion of a wheel. The limiter includes one or more first spiral slopes. The stopper includes one or more second spiral slopes in contact with the first spiral slopes.

The limiter may be ring-shaped. The first spiral slopes may be disposed along the circumference of the limiter. The limiter may further include one or more rotation stopping blocks which protrude between the spiral slopes.

The stopper may include a center body that is rotatably inserted between the rotation stopping blocks, and one or more protrusions that radially protrude from the center body. The second spiral slopes may be disposed on the protrusions.

### BRIEF DESCRIPTION OF THE DRAWINGS

For better understanding of the nature and objects of the present invention, reference should be made to the following detailed description with the accompanying drawings, in which:

FIG. 1 is a perspective view of a mechanism for changing a rack stroke of a steering system according to an embodiment of the invention;

FIG. 2 is a perspective view a limiter and stopper;

FIG. 3 is a side view of the limiter and stopper of FIG. 2;

FIGS. 4 and 5 are perspective view illustrating the limiter and stopper of FIGS. 2 and 3 in operation; and

FIG. 6 is a perspective view of an exemplary height sensor and vertical link.

### DETAILED DESCRIPTION OF THE PREFERRED EMBODIMENTS

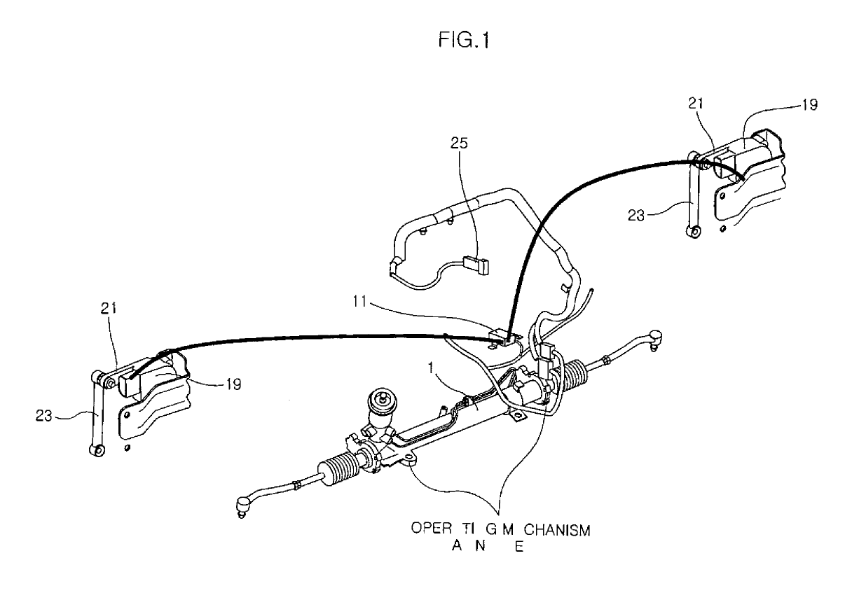

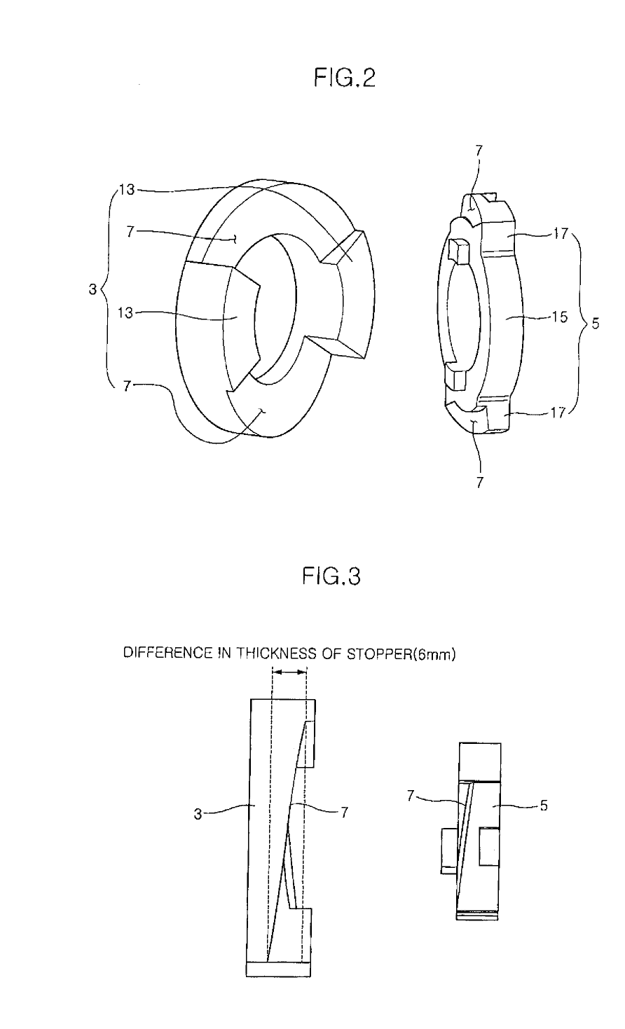

A mechanism for changing a rack stroke of a steering system including a limiter 3 that is rotated by a motor fixed to a steering housing 1, and a stopper 5 that limits the stroke of a steering rack by interfering with limiter 3. The limiter 3 and stopper 5 have spiral slopes 7 that contact with each other (see FIGS. 2 and 3). The mechanism also includes a sensor assembly that detects vertical motion of a car body; and a controller 11 that controls the motor in response to signals from the sensor assembly. The car body is connected to a steering knuckle by a suspension arm. The motor, limiter, and stopper together are called ‘operating mechanism’ in FIG. 1.

The center axes of limiter 3 and stopper 5 are disposed along the direction of motion of the steering rack. Their thicknesses in the axial direction vary along each spiral slope 7. Referring to FIG. 3, the thickness preferably varies by more than about 5 mm. An exemplary thickness is approximately 6 mm.

Because the thicknesses of the limiter 3 and stopper 5 vary, the adjustable stroke range of the steering rack is increased over that of the prior art. Therefore, it is possible to achieve a very low minimum turning radius in normal traveling conditions (i.e. without snow chains).

Limiter 3 is generally ring-shaped, with spiral slopes 7 symmetrically disposed along its circumference. Protruding rotation stopping blocks 13 are provided between spiral slopes 7.

Stopper 5 has a center body 15 that is rotatably inserted between rotation stopping blocks 13 of limiter 3, and radial protrusions 17 with spiral slopes 7.

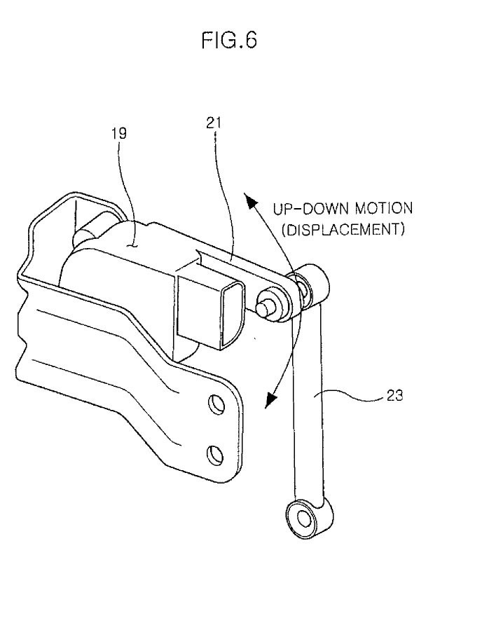

The suspension arm may be a lower arm. Referring to FIGS. 5 and 6, the sensor assembly includes a height sensor 19 fixed to the car body and a vertical link 23 that connects the lower arm to an input lever 21 of height sensor 19.

That is, height sensor 19 generates electrical signals corresponding to the amount of vertical motion of a wheel, depending on pivot angles of input lever 21. In response to the signals from height sensor 19, the controller 11 controls the motor to rotate the limiter 3 to its desired position.

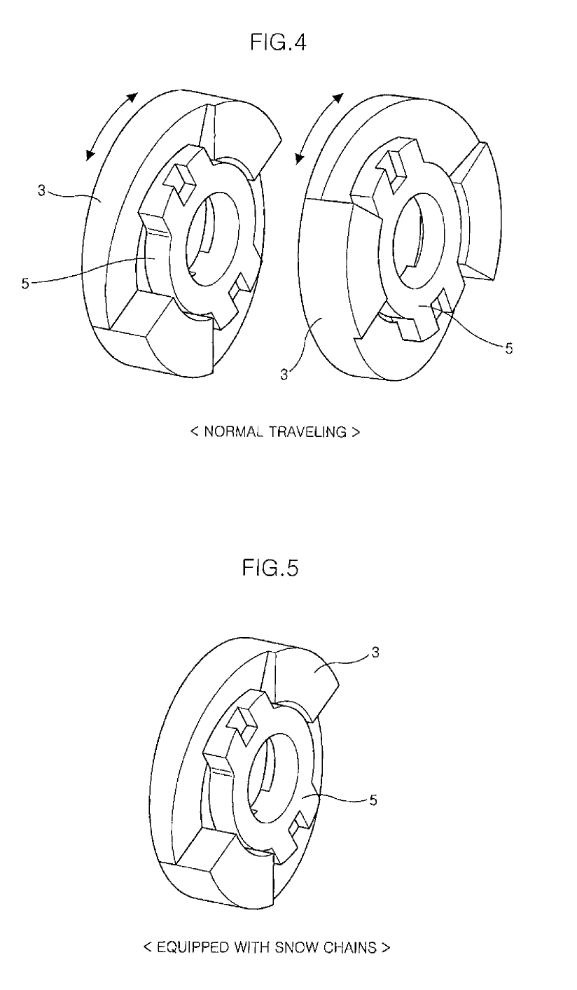

FIG. 4 shows limiter 3 and stopper 5 under normal conditions (without snow chains). When determining that a vehicle is in a normal traveling condition, with a small amount of vertical motion of tires, in response to a signal inputted from height sensor 19, controller 11 controls limiter 3 in real time using the motor, such that the vehicle's minimum turning radius is the lowest possible, by increasing the stroke of the steering rack within a possible range that is made from the amount of vertical motion of the tire. The stroke of the steering rack is less limited, and the vehicle's minimum turning radius is lower, in the right-hand drawing than the left-hand drawing in FIG. 4.

Further, FIG. 5 shows a condition when snow chains are fastened. The driver operates a switch 25, instructing the controller 11 to control the motor to rotate limiter 3 such that stopper 5 is inserted least in limiter 3, and the stroke of the steering rack is made in the minimum range.

Therefore, it is possible to maintain a sufficient gap without interference between the car body and the snow chains fastened around the tires.

Although the preferred embodiment of the present invention has been disclosed for illustrative purposes, those skilled in the art will appreciate that various modifications, additions and substitutions arc possible, without departing from the scope and spirit of the invention as defined in the accompanying claims.

What is claimed is:

1. A mechanism for changing a rack stroke of a steering system, comprising:
a limiter configured to be rotated by a motor, comprising one or more first spiral slopes;
a stopper configured to limit the rack stroke by contacting the limiter, comprising one or more second spiral slopes in contact with the first spiral slopes; and
a controller that controls the motor based on vertical motion of a wheel.

2. The mechanism as defined in claim 1, wherein the limiter is substantially ring-shaped; wherein the first spiral slopes are disposed along a circumference of the limiter, and wherein the limiter further comprises one or more rotation stopping blocks which protrude between the spiral slopes.

3. The mechanism as defined in claim 2, wherein the stopper comprises: a center body that is rotatably inserted between the rotation stopping blocks, and one or more protrusions that radially protrude from the center body, wherein the second spiral slopes are disposed on the protrusions.
